(19) United States
(12) Patent Application Publication
(10) Pub. No.: US 2022/0356674 A1
(43) Pub. Date: Nov. 10, 2022

(54) AUTOMATIC PATH TRACKING FOR POWER MACHINES

(71) Applicant: Clark Equipment Company, West Fargo, ND (US)

(72) Inventors: Caleb Norfleet, Cary, NC (US); Omar Aleman, San Francisco, CA (US); Erik Meike, Redwood City, CA (US); Anneka Noe, McLean, VA (US); Varun Singh, Tampa, FL (US); Caitlin Huang, Upland, CA (US); Tejus Rao, Rancho Cucamonga, CA (US); Matthew Spencer, Pasadena, CA (US)

(21) Appl. No.: 17/739,690

(22) Filed: May 9, 2022

Related U.S. Application Data
(60) Provisional application No. 63/185,630, filed on May 7, 2021.

(51) Int. Cl. E02F 9/20; E02F 9/22; G05D 1/02

(52) U.S. Cl. CPC E02F 9/2045; E02F 9/205; E02F 9/2253; G05D 1/0217; G05D 1/0223; G05D 1/0238; G05D 1/0274; G05D 2201/0202

(57) ABSTRACT

A power machine can be configured to automatically travel along a planned path based on pursuit of a target point. A location of the target point along the planned path can be determined based one or more of local curvature of the planned path or travel speed of the power machine. In some cases, a circular buffer can be used to store mapping data.

### CROSS-REFERENCE TO RELATED APPLICATIONS

This application claims priority to U.S. provisional patent application no. 63/185,630, titled “AUTOMATED PATH TRACKING FOR POWER MACHINES” and filed May 7, 2022, the entirety of which is incorporated herein by reference.

### BACKGROUND

This disclosure is directed toward power machines. More particularly, the present disclosure is directed toward automatic control of the movement of power machines over terrain, including along predetermined and adaptive planned paths. Power machines, for the purposes of this disclosure, include any type of machine that generates power for the purpose of accomplishing a particular task or a variety of tasks. One type of power machine is a work vehicle. Work vehicles, such as loaders, are generally self-propelled vehicles that have a work device, such as a lift arm (although some work vehicles can have other work devices) that can be manipulated to perform a work function. Work vehicles include loaders, excavators, utility vehicles, tractors, and trenchers, to name a few examples.

In some cases, control systems of power machines can execute operations without the presence or active intervention of a human operator. For example, pumps, motors, cylinders, and other actuators of a power machine can be electronically controlled in known ways to implement particular driving operations (e.g., steering operations, forward or reverse travel, etc.) and workgroup operations (e.g., operating a lift arm or an implement). Thus, one or more appropriately configured electronic control devices (e.g., hub controllers) can automatically control appropriate actuators, based on various operator and non-operator inputs, to automatically implement a variety of power machine operations. In some cases, automatic operation can include automatically tracking a planned path over terrain.

The discussion above is merely provided for general background information and is not intended to be used as an aid in determining the scope of the claimed subject matter.

### SUMMARY

Generally, examples disclosed herein can provide improved automatic (e.g., automated) travel for power machines, including over preplanned travel paths. For example, travel along a preplanned path can be implemented via commanded movement toward a target point along the preplanned path, and the location of the target point along the path can be adaptively updated, including based on current operating conditions of a power machine (e.g., travel speed) or environmental context (e.g., local path curvature). In some cases, a nearer location for a target point can be determined when travel speed for a power machine is relatively low and a more distant location for a target point can be determined when travel speed for a power machine is relatively high. Correspondingly, in some cases, a nearer location may correspond to a power machine approaching or executing a turn and a more distant location may correspond to a power machine traveling along a generally low-curvature portion of a path. In some cases, implementation of an adaptively update target point can improve smoothing of an actual travel path of a power machine and thereby generally increase operational efficiency.

Some examples of the disclosure provide a method for controlling travel of a power machine (e.g., automatically controlling automatic travel) that can be implemented using one or more processor devices (e.g., general or special purpose electronic controllers). A planned path for travel of the power machine can be identified between a starting location and a destination. A target point along the planned path can be determined based on a set distance of the target point from the power machine, and commanding travel of the power machine toward the target point. One or more tractive elements of the power machine can be controlled to cause the power machine to automatically travel toward the target point. As the power machine automatically travels toward the target point, the set distance can be updated based on one or more of a local curvature of the planned path or a travel speed of the power machine. As the power machine automatically travels toward the target point, a location of the target point along the planned path can be updated based on the updated set distance.

In some example, updating a set distance of a target point from a power machine includes increasing the set distance based on an increase in the travel speed of the power machine and decreasing the set distance based on a decrease in the travel speed of the power machine. In some example, a commanded travel speed of a power machine can be automatically decreased based on increases in a local curvature of the planned path and the commanded travel speed of the power machine can be automatically increased based on decreases in the local curvature of the planned path.

In some examples, controlling one or more tractive elements to cause a power machine to automatically travel toward a target point can cause the power machine to deviate from a planned path. In some examples, the deviation from the planned path can result in an actual travel path of the power machine that is locally shorter than the planned path, between common endpoints along the planned path. In some examples, the deviation from the planned path can result in a total actual travel path of the power machine from the starting location to the destination that is shorter than the planned path as measured from the starting location to the destination.

In some examples, updating a set distance of a target point from the power machine can be further based on a selection (e.g., a user selection) of at least one operating mode of a plurality of predetermined operating modes for path tracking by the power machine.

In some examples, updating a set distance of a target point from the power machine can be further based on a turning radius of the power machine.

In some examples, updating a set distance of a target point from the power machine includes increasing the set distance to a maximum value upon substantial completion of a turn along the planned path.

Some examples provide a power machine configured for automatic operations. The power machine can include a main frame, one or more tractive elements configured to move the main frame over terrain, one or more work elements supported by the main frame, and a power source supported by the main frame and configured to provide tractive power to the one or more tractive elements and to provide working power to the one or more work elements. A control system can include one or more processor devices configured to execute control operations, including: identifying a first local curvature of a planned path for automatic travel of the power machine; setting a first target travel speed for the power machine based on the first local curvature; determining a current location for the power machine; identifying a first location of a target point along the planned path, based on the current location of the power machine and one or more of the first local curvature or the first target travel speed; and controlling automatic travel of the power machine, including commanding a first heading for the power machine based on the identified first location of the target point to automatically control travel of the power machine.

In some examples, identifying a first location of a target point along a planned path, based on the one or more of a first local curvature or a first target travel speed, includes determining the first target travel speed based on the first local curvature and identifying the location of the target point based on the first target travel speed.

In some examples, as a power machine travels toward a target point along a first heading, an updated location of the target point along the planned path can be identified based on one or more of a second local curvature of the planned path or a second travel speed of the power machine. Controlling automatic travel of the power machine can include commanding an updated heading for the power machine based on the identified updated location of the target point.

In some examples, identifying an updated location of a target point includes, as a power machine travels toward the target point, updating a distance between the power machine and the target point based on one or more of a (e.g., second) local curvature of a planned path or a (e.g., second) travel speed of the power machine.

In some examples, automatically controlling travel of a power machine can include one or more of: automatically increasing a distance between a target point and a reference location on the power machine based on an increase in travel speed of the power machine; automatically decreasing the distance between the target point and the reference location based on a decrease in the travel speed of the power machine; automatically decreasing a commanded travel speed of the power machine based on increases in local curvature of the planned path; or automatically increasing the commanded travel speed of the power machine based on decreases in local curvature of the planned path.

In some examples, user input can be received indicating a selection of an operating mode from a plurality of operating modes. In response to receiving the user input, a power machine can be operated for automatic travel in the selected operating mode, wherein each of the plurality of operating modes specifies a respective correspondence between (a) a distance between the power machine and a target point and (b) one or more of: travel speed of the power machine or local curvature of a planned path.

In some examples, one or more sensors can be arranged to detect data representing aspects of the terrain. A control system can include a circular buffer memory structure. The control system can be configured to: store in the circular buffer memory structure an initial map of a first area of the terrain; receive data from the one or more sensors representing one or more of: one or more potential obstacles within the terrain, or a second area of the terrain that extends beyond an edge of the first area of the terrain; and store an updated map of the terrain in the circular buffer memory structure, including a representation of the one or more of: the one or more potential obstacles within the terrain, or the second area of the terrain that extends beyond an edge of the first area of the terrain. In some examples, storing the updated map can overwrite at least part of the initial map within the circular buffer module.

Some examples provide a power machine configured for automatic operations. The power machine can include a main frame, one or more tractive elements configured to move the main frame over terrain, a power source supported by the main frame and configured to provide tractive power to the one or more tractive elements, and a control system that includes a circular buffer module and one or more processor devices. The control system can be configured to: store in the circular buffer module an initial representation of a first area of the terrain; control automatic travel of the power machine, including commanding first tractive operations by the one or more tractive elements based on the initial representation of the terrain; receive data from one or more sensors corresponding to one or more of: one or more potential obstacles within the terrain, or a second area of the terrain that extends beyond an edge of the first area of the terrain; store an updated representation of the terrain in the circular buffer, including a representation of the one or more of: the one or more potential obstacles within the terrain, or the second area of the terrain that extends beyond an edge of the first area of the terrain; and further control automatic travel of the power machine, including commanding second tractive operations by the one or more tractive elements based on the updated representation of the terrain.

In some examples, a control system can be further configured to: store an offset for a circular buffer that locates a power machine within a first area of terrain; and update the offset based upon receiving the data corresponding to a second area of the terrain.

In some examples, a second area of terrain represented by an updated representation can be of substantially the same areal size as a first area of the terrain represented by an initial representation.

This Summary and the Abstract are provided to introduce a selection of concepts in a simplified form that are further described below in the Detailed Description. The Summary and the Abstract are not intended to identify key features or essential features of the claimed subject matter, nor are they intended to be used as an aid in determining the scope of the claimed subject matter.

### BRIEF DESCRIPTION OF THE DRAWINGS

FIG. 1 is a block diagram illustrating functional systems of a representative power machine on which embodiments of the present disclosure can be advantageously practiced.

FIG. 2 is a perspective view showing generally a front of a power machine on which embodiments disclosed in this specification can be advantageously practiced.

FIG. 3 is a perspective view showing generally a back of the power machine shown in FIG. 2.

FIG. 4 is a block diagram illustrating components of a power system of a loader such as the loader of FIGS. 2 and 3.

FIG. 5 is a block diagram illustrating a control method for automatic travel for power machines according to an embodiment of the disclosure.

FIG. 6 is a schematic diagram illustrating aspects of mapping operations under some examples of the control method of FIG. 5.

FIGS. 7A and 7B are schematic diagrams illustrating aspects of mapping operations under some examples of the control method of FIG. 5.

FIG. 8 is a schematic diagram illustrating aspects of path planning operations under some examples of the control method of FIG. 5.

FIG. 9 is a schematic diagram illustrating aspects of path tracking operations under some examples of the control method of FIG. 5.

FIGS. 10A through 10D are schematic diagrams illustrating further aspects of path tracking operations under some examples of the control method of FIG. 5, including adaptive placement of a target point.

FIGS. 11 and 12 are schematic diagrams illustrating still further aspects of tracking operations under some examples of the control method of FIG. 5, including certain path smoothing effects.

FIGS. 13 and 14 are block diagrams illustrating control methods for power machines according to embodiments of the disclosure, including as may be implemented as a part of the method of FIG. 5.

### DETAILED DESCRIPTION

The concepts disclosed in this discussion are described and illustrated with reference to exemplary embodiments. These concepts, however, are not limited in their application to the details of construction and the arrangement of components in the illustrative embodiments and are capable of being practiced or being carried out in various other ways. The terminology in this document is used for the purpose of description and should not be regarded as limiting. Words such as “including,” “comprising,” and “having” and variations thereof as used herein are meant to encompass the items listed thereafter, equivalents thereof, as well as additional items.

As used herein, unless otherwise specified, “substantially the same” (or variations thereof) indicates that two values deviate from each other by 5% or less, with reference to the value with a smaller absolute size. In this regard, for example, the values 100 and 105 are substantially the same because they deviate from each other by 5%.

Also as used herein, unless otherwise specified, a “turn” indicates a part of a path of travel of a power machine (e.g., of an actual or a planned path of travel) that exhibits non-zero curvature and links two other parts of the path that respectively exhibit substantially zero curvature (i.e., having less than 5 degrees of local variation of tangent lines over at least a length of the relevant power machine) or opposite curvature as the turn (e.g., in the case of an S-curve). Similarly, “substantial completion” of a turn (and the like, e.g., “substantially completing,” etc.) indicates that a reference point (e.g., leading edge, center of gravity, or center of rotation) of a power machine or a tractive element thereof has traveled along the turn to a point that is one or more of: at least halfway through the path of the leading edge along the turn, or past a point of maximum curvature for the turn.

Also as used herein, unless otherwise specified, curvature indicates the mathematical curvature (i.e., 1/R) of smoothly curving paths or path segments or the angular change of a path or path segment formed from straight (or other) lines that extend between nodes, as measured relative to an unchanged forward-travel direction at the relevant point. Thus, for example, for a path that extends along a first straight-line segment to a node point and then along a second straight-line segment from the node point, the curvature at the node point is the angle, at the node, between the second line segment and a straight extension of the first line segment past the node point. In some examples, nodes can be points in a path map at intersections between path lines. In some examples, nodes can be curved or other transitional paths between path lines. (e.g., a short, curved path segment that defines internal curvature as well as extending along a node-defined curvature between two straight-line path segments).

As also noted above, during automatic travel of a power machine over terrain, the heading of the power machine can sometimes be controlled based on one or more planned paths. For example, an initial planned path that extends between a starting location and a destination can be predetermined (e.g., before the power machine starts to travel from a starting point), based on known or detected obstacles or other aspects of the terrain, other environmental factors, characteristics of the power machine or a planned operation, etc. The power machine can then be commanded to travel in directions that will cause the power machine to approximately follow the planned path. Further, in some cases, a planned path can be updated adaptively during the commanded travel, as sensors or other inputs introduce new data regarding the terrain, the power machine, etc.

In some cases, to improve the efficiency and smoothness of operation, a power machine can be commanded to travel toward a target point that is located on a planned path ahead of the power machine relative to the direction of travel. However, an optimal distance between a power machine and a target point may vary depending on different factors. Accordingly, some embodiments of the present disclosure include methods, control systems, and power machines systems generally that are configured to operate with automatically varying distances between a target point along a planned path and a power machine that is tracking the planned path by pursuing the target point.

In some cases, an optimal distance of a target point from a power machine during target-chasing travel may depend on operational characteristics of the power machine (e.g., turn radius, travel speed, etc.) or on the characteristics of a particular part of a planned path (e.g., a local curvature of the path, representing a turn that the power machine is approaching or currently navigating, the presence of one or more obstacles within a virtual map of the terrain, etc.). Accordingly, in some embodiments, a distance of a target point from a power machine that is tracking a planned path can be automatically adjusted based on current or expected operational characteristics of a power machine (e.g., current or commanded travel speed) or current or upcoming characteristics of a planned path (e.g., average curvature of a path along a turn that has been reached by a target point or that is within a particular range of a power machine). For example, some control systems can be configured to automatically reduce a distance of a target point from a power machine based on the power machine approaching (or moving along) a part of a path that exhibits an increase in local curvature (e.g., a turn between straight segments of the path), and to increase the distance based on the power machine approaching (or moving along) a part of the path that exhibits a decrease in local curvature (e.g., the end of a turn). Thus, in some cases, the power machine may tend to “cut off” less of a corner or other turn, because the target point toward which travel of the power machine is commanded may be automatically moved to be closer to the power machine along the path as the power machine approaches the turn. Further, the power machine may tend to oscillate less substantially along (and about) straighter portions of the path because a more distant target point can allow for more gradual adjustments of travel vectors to more closely approximate the planned path.

As another example, some control systems can be configured to automatically reduce a distance of a target point from a power machine based on a decrease in travel speed of the power machine (e.g., a detected or derived current travel speed, or a commanded target travel speed), and to decrease the distance of the target point from the power machine based on an increase in travel speed of the power machine. In this arrangement, similar benefits along turns and other path segments can be obtained as are generally discussed above. Indeed, in some cases, adjustment of a location of a target point based directly on travel speed can correspond to adjustment of the location of the target point based indirectly on path geometry (e.g., local curvature), and vice versa. For example, in some embodiments, a control system can be configured to automatically command an adjusted travel speed for a power machine based on local path curvature (e.g., to reduce speed for increased curvature), and to automatically command an adjusted location of a target point along a path based on travel speed.

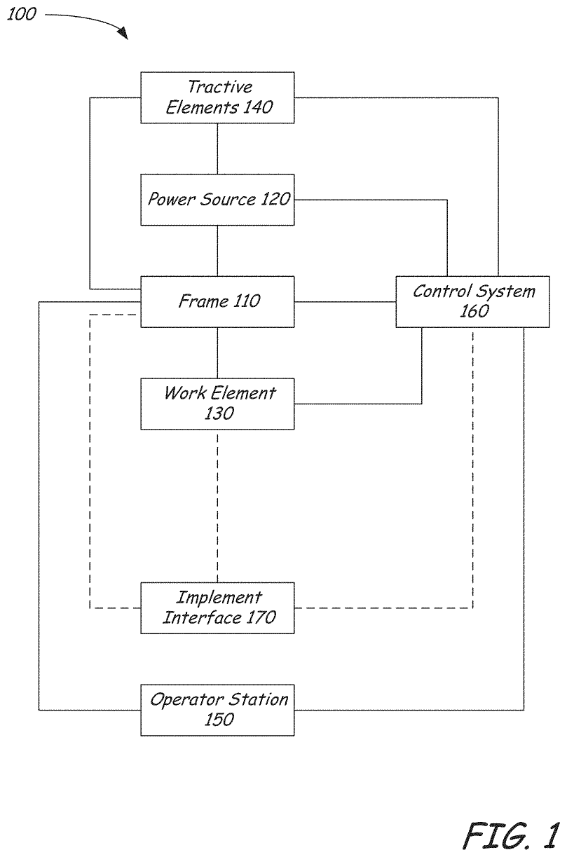

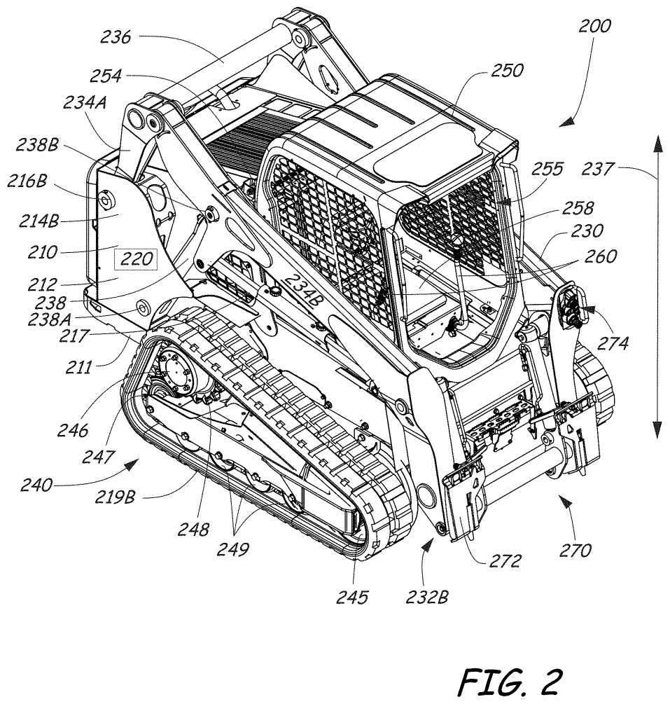

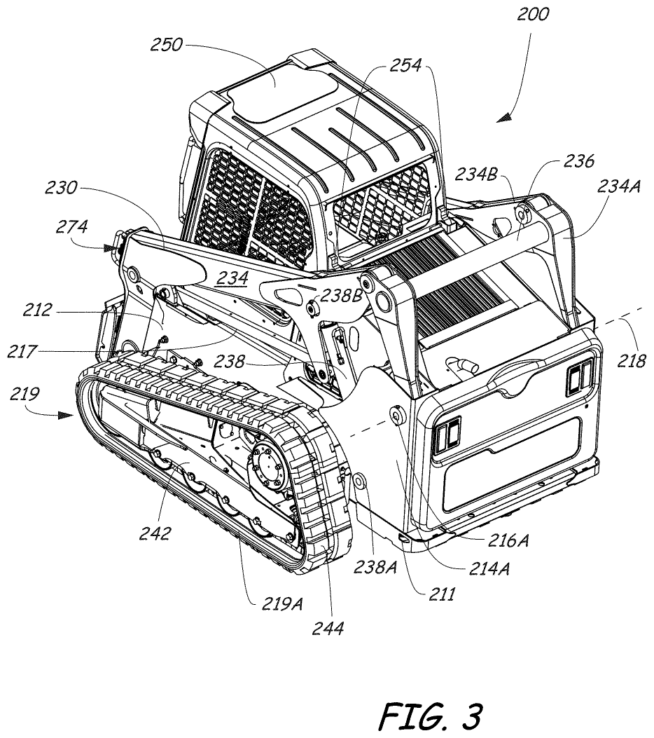

These concepts can be practiced on various power machines, as will be described below. A representative power machine on which the embodiments can be practiced is illustrated in diagram form in FIG. 1 and one example of such a power machine is illustrated in FIGS. 2-3 and described below before any embodiments are disclosed. For the sake of brevity, only one power machine is discussed. However, as mentioned above, the embodiments below can be practiced on any of a number of power machines, including power machines of different types from the representative power machine shown in FIGS. 2-3. Power machines, for the purposes of this discussion, include a frame, at least one work element, and a power source that can provide power to the work element to accomplish a work task. One type of power machine is a self-propelled work vehicle. Self-propelled work vehicles are a class of power machines that include a frame, work element, and a power source that can provide power to the work element. At least one of the work elements is a motive system for moving the power machine under power.

FIG. 1 illustrates a block diagram illustrates the basic systems of a power machine 100 upon which the embodiments discussed below can be advantageously incorporated and can be any of a number of different types of power machines. The block diagram of FIG. 1 identifies various systems on power machine 100 and the relationship between various components and systems. As mentioned above, at the most basic level, power machines for the purposes of this discussion include a frame, a power source, and a work element. The power machine 100 has a frame 110, a power source 120, and a work element 130. Because power machine 100 shown in FIG. 1 is a self-propelled work vehicle, it also has tractive elements 140, which are themselves work elements provided to move the power machine over a support surface and an operator station 150 that provides an operating position for controlling the work elements of the power machine. A control system 160 is provided to interact with the other systems to perform various work tasks at least in part in response to control signals provided by an operator or other input device. For example, the control system 160 can be an integrated or distributed architecture of one or more processor devices and one or more memories that are collectively configured to receive operator input or other input signals (e.g., sensor data) and to output commands accordingly for power machine operations.

Certain work vehicles have work elements that are capable of performing a dedicated task. For example, some work vehicles have a lift arm to which an implement such as a bucket is attached such as by a pinning arrangement. The work element, i.e., the lift arm can be manipulated to position the implement for the purpose of performing the task. The implement, in some instances can be positioned relative to the work element, such as by rotating a bucket relative to a lift arm, to further position the implement. Under normal operation of such a work vehicle, the bucket is intended to be attached and under use. Such work vehicles may be able to accept other implements by disassembling the implement/work element combination and reassembling another implement in place of the original bucket. Other work vehicles, however, are intended to be used with a wide variety of implements and have an implement interface such as implement interface 170 shown in FIG. 1. At its most basic, implement interface 170 is a connection mechanism between the frame 110 or a work element 130 and an implement, which can be as simple as a connection point for attaching an implement directly to the frame 110 or a work element 130 or more complex, as discussed below.

On some power machines, implement interface 170 can include an implement carrier, which is a physical structure movably attached to a work element. The implement carrier has engagement features and locking features to accept and secure any of a number of implements to the work element. One characteristic of such an implement carrier is that once an implement is attached to it, it is fixed to the implement (i.e. not movable with respect to the implement) and when the implement carrier is moved with respect to the work element, the implement moves with the implement carrier. The term implement carrier as used herein is not merely a pivotal connection point, but rather a dedicated device specifically intended to accept and be secured to various different implements. The implement carrier itself is mountable to a work element 130 such as a lift arm or the frame 110. Implement interface 170 can also include one or more power sources for providing power to one or more work elements on an implement. Some power machines can have a plurality of work element with implement interfaces, each of which may, but need not, have an implement carrier for receiving implements. Some other power machines can have a work element with a plurality of implement interfaces so that a single work element can accept a plurality of implements simultaneously. Each of these implement interfaces can, but need not, have an implement carrier.

Frame 110 includes a physical structure that can support various other components that are attached thereto or positioned thereon. The frame 110 can include any number of individual components. Some power machines have frames that are rigid. That is, no part of the frame is movable with respect to another part of the frame. Other power machines have at least one portion that is capable of moving with respect to another portion of the frame. For example, excavators can have an upper frame portion that rotates with respect to a lower frame portion. Other work vehicles have articulated frames such that one portion of the frame pivots with respect to another portion for accomplishing steering functions.

Frame 110 supports the power source 120, which is capable of providing power to one or more work elements 130 including the one or more tractive elements 140, as well as, in some instances, providing power for use by an attached implement via implement interface 170. Power from the power source 120 can be provided directly to any of the work elements 130, tractive elements 140, and implement interfaces 170. Alternatively, power from the power source 120 can be provided to a control system 160, which in turn selectively provides power to the elements that capable of using it to perform a work function. Power sources for power machines typically include an engine such as an internal combustion engine and a power conversion system such as a mechanical transmission or a hydraulic system that is capable of converting the output from an engine into a form of power that is usable by a work element. Other types of power sources can be incorporated into power machines, including electrical sources or a combination of power sources, known generally as hybrid power sources.

FIG. 1 shows a single work element designated as work element 130, but various power machines can have any number of work elements. Work elements are typically attached to the frame of the power machine and movable with respect to the frame when performing a work task. In addition, tractive elements 140 are a special case of work element in that their work function is generally to move the power machine 100 over a support surface. Tractive elements 140 are shown separate from the work element 130 because many power machines have additional work elements besides tractive elements, although that is not always the case. Power machines can have any number of tractive elements, some or all of which can receive power from the power source 120 to propel the power machine 100. Tractive elements can be, for example, wheels attached to an axle, track assemblies, and the like. Tractive elements can be mounted to the frame such that movement of the tractive element is limited to rotation about an axle (so that steering is accomplished by a skidding action) or, alternatively, pivotally mounted to the frame to accomplish steering by pivoting the tractive element with respect to the frame.

Power machine 100 includes an operator station 150 that includes an operating position from which an operator can control operation of the power machine. In some power machines, the operator station 150 is defined by an enclosed or partially enclosed cab. Some power machines on which the disclosed embodiments may be practiced may not have a cab or an operator compartment of the type described above. For example, a walk behind loader may not have a cab or an operator compartment, but rather an operating position that serves as an operator station from which the power machine is properly operated. More broadly, power machines other than work vehicles may have operator stations that are not necessarily similar to the operating positions and operator compartments referenced above. Further, some power machines such as power machine 100 and others, whether or not they have operator compartments or operator positions, may be capable of being operated remotely (i.e. from a remotely located operator station) instead of or in addition to an operator station adjacent or on the power machine. This can include applications where at least some of the operator controlled functions of the power machine can be operated from an operating position associated with an implement that is coupled to the power machine. Alternatively, with some power machines, a remote control device can be provided (i.e. remote from both of the power machine and any implement to which is it coupled) that is capable of controlling at least some of the operator controlled functions on the power machine.

FIGS. 2-3 illustrates a loader 200, which is one particular example of a power machine of the type illustrated in FIG. 1 where the embodiments discussed below can be advantageously employed. Loader 200 is a track loader and more particularly, a compact tracked loader. A track loader is a loader that has endless tracks as tractive elements (as opposed to wheels). Track loader 200 is one particular example of the power machine 100 illustrated broadly in FIG. 1 and discussed above. To that end, features of loader 200 described below include reference numbers that are generally similar to those used in FIG. 1. For example, loader 200 is described as having a frame 210, just as power machine 100 has a frame 110. Track loader 200 is described herein to provide a reference for understanding one environment on which the embodiments described below related to track assemblies and mounting elements for mounting the track assemblies to a power machine may be practiced. The loader 200 should not be considered limiting especially as to the description of features that loader 200 may have described herein that are not essential to the disclosed embodiments and thus may or may not be included in power machines other than loader 200 upon which the embodiments disclosed below may be advantageously practiced. Unless specifically noted otherwise, embodiments disclosed below can be practiced on a variety of power machines, with the track loader 200 being only one of those power machines. For example, some or all of the concepts discussed below can be practiced on many other types of work vehicles such as various other loaders, excavators, trenchers, and dozers, to name but a few examples.

Loader 200 includes frame 210 that supports a power system 220, the power system being capable of generating or otherwise providing power for operating various functions on the power machine. Frame 210 also supports a work element in the form of a lift arm structure 230 that is powered by the power system 220 and can perform various work tasks. As loader 200 is a work vehicle, frame 210 also supports a traction system 240, which is also powered by power system 220 and can propel the power machine over a support surface. The lift arm structure 230 in turn supports an implement carrier 272, which can receive and securing various implements to the loader 200 for performing various work tasks. The loader 200 can be operated from an operator station 250 from which an operator can manipulate various control devices to cause the power machine to perform various functions. A control system 260 is provided for controlling the various functions of the loader 200.

Various power machines that can include or interact with the embodiments discussed below can have various different frame components that support various work elements. The elements of frame 210 discussed herein are provided for illustrative purposes and should not be considered to be the only type of frame that a power machine on which the embodiments can be practiced can employ. Frame 210 of loader 200 includes an undercarriage or lower portion 211 of the frame and a mainframe or upper portion 212 of the frame that is supported by the undercarriage. The mainframe 212 of loader 200 is attached to the undercarriage 211 such as with fasteners or by welding the undercarriage to the mainframe. Mainframe 212 includes a pair of upright portions 214 located on either side and toward the rear of the mainframe (only one is shown in FIG. 2) that support a lift arm structure 230 and to which the lift arm structure 230 is pivotally attached. The lift arm structure 230 is illustratively pinned to each of the upright portions 214. The combination of mounting features on the upright portions 214 and the lift arm structure 230 and mounting hardware (including pins used to pin the lift arm structure to the mainframe 212) are collectively referred to as joints 216 (one is located on each of the upright portions 214) for the purposes of this discussion. Joints 216 are aligned along an axis 218 so that the lift arm structure is capable of pivoting, as discussed below, with respect to the frame 210 about axis 218. Other power machines may not include upright portions on either side of the frame or may not have a lift arm structure that is mountable to upright portions on either side and toward the rear of the frame. For example, some power machines may have a single arm, mounted to a single side of the power machine or to a front or rear end of the power machine. Other machines can have a plurality of work elements, including a plurality of lift arms, each of which is mounted to the machine in its own configuration. Frame 210 also supports a pair of tractive elements 242 on either side of the loader 200 (only one is shown in FIG. 2), which on loader 200 are track assemblies.

The lift arm structure 230 shown in FIG. 1 is one example of many different types of lift arm structures that can be attached to a power machine such as loader 200 or other power machines on which embodiments of the present discussion can be practiced. The lift arm structure 230 has a pair of lift arms 232 that are disposed on opposing sides of the frame 210. A first end 232A of each of the lift arms 232 is pivotally coupled to the power machine at joints 216 and a second end 232B of each of the lift arms is positioned forward of the frame 210 when in a lowered position as shown in FIG. 2. The lift arm structure 230 is moveable (i.e. the lift arm structure can be raised and lowered) under control of the loader 200 with respect to the frame 210. That movement (i.e. the raising and lowering of the lift arm structure 230) is described by a travel path, shown generally by arrow 237. For the purposes of this discussion, the travel path 233 of the lift arm structure 230 is defined by the path of movement of the second end 232B of the lift arm structure.

Each of the lift arms 232 of lift arm structure 230 as shown in FIG. 2 includes a first portion 234A and a second portion 234B that is pivotally coupled to the first portion 234A. The first portion 234A of each lift arm 234 is pivotally coupled to the frame 210 at one of the joints 216 and the second portion 234B extends from its connection to the first portion 234A to the second end 232B of the lift arm structure 230. The lift arms 232 are each coupled to a cross member 236 that is attached to the first portions 234A. Cross member 236 provides increased structural stability to the lift arm structure 230. A pair of actuators 238 (only one is shown in FIG. 1), which on loader 200 are hydraulic cylinders configured to receive pressurized fluid from power system 220, are pivotally coupled to both the frame 210 and the lift arms 234 at pivotable joints 238A and 238B, respectively, on either side of the loader 200. The actuators 238 are sometimes referred to individually and collectively as lift cylinders. Actuation (i.e., extension and retraction) of the actuators 238 cause the lift arm structure 230 to pivot about joints 216 and thereby be raised and lowered along a fixed path illustrated by arrow 237. Each of a pair of control links 217 (only one is shown) are pivotally mounted to the frame 210 and one of the lift arms 232 on either side of the frame 210. The control links 217 help to define the fixed travel path of the lift arm structure 230. The lift arm structure 230 shown in FIG. 2 is representative of one type of lift arm structure that may be coupled to the power machine 100. Other lift arm structures, with different geometries, components, and arrangements can be pivotally coupled to the loader 200 or other power machines upon which the embodiments discussed herein can be practiced without departing from the scope of the present discussion. For example, other machines can have lift arm structures with lift arms that each has one portion (as opposed to the two portions 234A and 234B of lift arm 234) that is pivotally coupled to a frame at one end with the other end being positioned in front of the frame. Other lift arm structures can have an extendable or telescoping lift arm. Still other lift arm structures can have several (i.e. more than two) portions segments or portions. Some lift arms, most notably lift arms on excavators but also possible on loaders, may have portions that are controllable to pivot with respect to another segment instead of moving in concert (i.e. along a pre-determined path) as is the case in the lift arm structure 230 shown in FIG. 2. Some power machines have lift arm structures with a single lift arm, such as is known in excavators or even some loaders and other power machines. Other power machines can have a plurality of lift arm structures, each being independent of the other(s).

An exemplary implement interface 270 is provided at a second end 234B of the arm 234. The implement interface 270 includes an implement carrier 272 that is capable of accepting and securing a variety of different implements to the lift arm 230. Such implements have a machine interface that is configured to be engaged with the implement carrier 272. The implement carrier 272 is pivotally mounted to the second end 234B of the arm 234. Implement carrier actuators 233 are operably coupled the lift arm structure 230 and the implement carrier 272 and are operable to rotate the implement carrier with respect to the lift arm structure.

The implement interface 270 also includes an implement power source 235 available for connection to an implement on the lift arm structure 230. The implement power source 235 includes pressurized hydraulic fluid port to which an implement can be coupled. The pressurized hydraulic fluid port selectively provides pressurized hydraulic fluid for powering one or more functions or actuators on an implement. The implement power source can also include an electrical power source for powering electrical actuators or an electronic controller on an implement. The electrical power source 235 also exemplarily includes electrical conduits that are in communication with a data bus on the excavator 200 to allow communication between a controller on an implement and electronic devices on the loader 200. It should be noted that the specific implement power source on loader 200 does not include an electrical power source.

The lower frame 211 supports and has attached to it a pair of tractive elements 242, identified in FIGS. 2-3 as left track assembly 240A and right track assembly 240B. Each of the tractive elements 242 has a track frame 243 that is coupled to the lower frame 211. The track frame 243 supports and is surrounded by an endless track 244, which rotates under power to propel the loader 200 over a support surface. Various elements are coupled to or otherwise supported by the track frame 243 for engaging and supporting the endless track 244 and cause it to rotate about the track frame. For example, a sprocket 246 is supported by the track frame 243 and engages the endless track 244 to cause the endless track to rotate about the track frame. An idler 245 is held against the track 244 by a tensioner (not shown) to maintain proper tension on the track. The track frame 243 also supports a plurality of rollers 249, which engage the track and, through the track, the support surface to support and distribute the weight of the loader 200.

Upper frame portion 212 supports cab 252, which defines, at least in part, operator compartment or station 250. A seat 254 is provided within cab 252 in which an operator can be seated while operating the excavator. While sitting in the seat 254, an operator will have access to a plurality of operator input devices 256 that the operator can manipulate to control various work functions, such as manipulating the lift arm 230, the traction system 240, and so forth.

Display devices are provided in the cab to give indications of information relatable to the operation of the power machines in a form that can be sensed by an operator, such as, for example audible or visual indications. Audible indications can be made in the form of buzzers, bells, and the like or via verbal communication. Visual indications can be made in the form of graphs, lights, icons, gauges, alphanumeric characters, and the like. Displays can be dedicated to providing dedicated indications, such as warning lights or gauges, or dynamic to provide programmable information, including programmable display devices such as monitors of various sizes and capabilities. Display devices can provide diagnostic information, troubleshooting information, instructional information, and various other types of information that assists an operator with operation of the power machine or an implement coupled to the power machine. Other information that may be useful for an operator can also be provided.

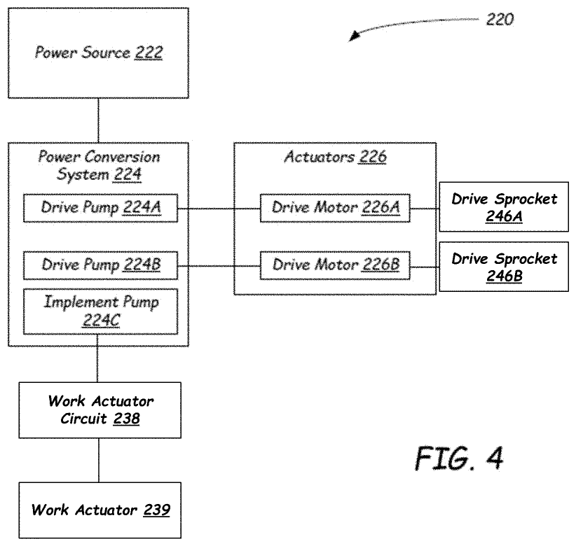

FIG. 4 illustrates power system 220 in more detail. Broadly speaking, power system 220 includes one or more power sources 222 that can generate or store power for operating various machine functions. On loader 200, the power system 220 includes an internal combustion engine. Other power machines can include electric generators, rechargeable batteries, various other power sources or any combination of power sources that can provide power for given power machine components. The power system 220 also includes a power conversion system 224, which is operably coupled to the power source 222. Power conversion system 224 is, in turn, coupled to one or more actuators 226, which can perform a function on the power machine. Power conversion systems in various power machines can include various components, including mechanical transmissions, hydraulic systems, electrical power systems, and the like.

In the illustrated example, the power conversion system 224 of power machine 200 includes a hydrostatic drive pump 224A, which provides a power signal to drive motors 226A and 226B. The drive motors 226A, 226B in turn are each operably coupled to respective drive sprockets 246A, 246B to drive the endless tracks 244. Although not shown, one or more (e.g., two) drive motors or other actuators can sometimes power one or more (e.g., four) axles, which can in turn be coupled to wheels or other tractive elements. In some embodiments, a wheeled (or other) skid steer system can be provided, with each of the drive motors 226A, 226B, for example, powering a respective set of two axles (not shown) so that turning operations can be accomplished by different applications of tractive power on opposing sides of the power machine 200 (e.g., rather than by pivoting an axle, wheel, or frame assembly).

The hydrostatic drive pump 224A can be mechanically, hydraulically, or electrically coupled to operator input devices to receive actuation signals for controlling the drive pump. The power conversion system also includes an implement pump 224C, which is also driven by the power source 222. The implement pump 224C is configured to provide pressurized hydraulic fluid to a work actuator circuit 238, which is in communication with work actuator 239. Work actuator 239 is representative of a plurality of actuators, including the lift cylinder, tilt cylinder, telescoping cylinder, and the like. The work actuator circuit 238 can include valves and other devices to selectively provide pressurized hydraulic fluid to the various work actuators represented by block 239 in FIG. 4. In addition, the work actuator circuit 238 can be configured to provide pressurized hydraulic fluid to work actuators on an attached implement.

In some embodiments, as also generally noted above, similarly arranged power conversion systems may operate to receive and utilize electrical power. For example, electric motors can be provided in place of the drive motors 226A, 226B to receive operational power from an electrical power source rather than from the drive pump 224A.

The description of power machine 100 and loader 200 above is provided for illustrative purposes, to provide illustrative environments on which the embodiments discussed below can be practiced. While the embodiments discussed can be practiced on a power machine such as is generally described by the power machine 100 shown in the block diagram of FIG. 1 and more particularly on a loader such as track loader 200, unless otherwise noted or recited, the concepts discussed below are not intended to be limited in their application to the environments specifically described above.

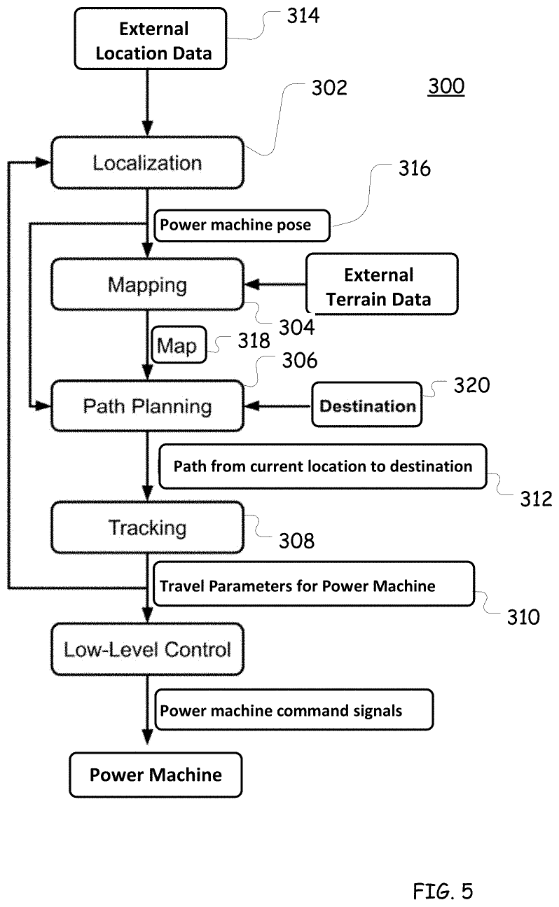

As generally noted above, in some embodiments, a power machine can be controlled to track a planned path based on automatic adjustments of a target point along the planned path. In different embodiments, control systems for power machines can operate to automatically determine a planned path and automatically provide electronic command signals for operation of the power machine to track the planned path (e.g., based on known protocols for motor control and generally known feedback systems). As one example, FIG. 5 generally illustrates a method 300 for automatic control of a power machine 330 (e.g., either of the power machines 100, 200, an electrically or otherwise powered wheeled skid steer loader, etc.). Generally, the illustrated operations of the method 300 can progress in order (and iteratively) through a localization block 302, a mapping block 304, a path planning block 306, and a tracking block 308, to automatically determine travel parameters 310 for the power machine that correspond to travel along a planned path 312. For example, based on operations at blocks 302, 304, 306, or 308, travel parameters 310 can be determined as linear and angular velocities corresponding to a current power machine pose, a determined heading for path tracking, or appropriate other operating conditions. As generally discussed above, a variety of known approaches can then be used, including via known low-level control modules (e.g., via operation of motor, drive or other controllers at block 322), to provide command signals for tractive (or other) systems of the power machine. For example, once travel parameters 310 have been determined, a variety of known approaches can be employed to send electronic commands to work elements of a power machine (e.g., via dedicated implement controllers or drive controllers), including via remote control systems, integrated control systems, or combinations of local and remote control systems, to implement the intended control.

During execution of the method 300, a control system can regularly (e.g., cyclically) receive input data from one or more sensors or other input devices, to inform execution of various operations of the method. Some input data may be external location data 314 that may indicate a global or relative position or orientation (e.g., absolute or relative heading) of a power machine. For example, to inform localization of a power machine at block 302 (e.g., identification of a current location and orientation of the power machine) some control systems can include GPS devices (or other similar equipment) that can provide external location data or orientation data for the power machines based on known processing of signals from satellite or beacon sources. In some cases, a power machine can include two or more GPS devices, so that two distinct signals can be analyzed and a more accurate estimation of the location or orientation of the power machine can be determined.

In some embodiments, due to the noisy nature and inherent accuracy limitations of GPS signals, further operations may be beneficial to more reliably determine a current location or orientation of a power machine (collectively, the “pose” of the power machine). For example, some known approaches can use extended Kalman filtering to provide improved estimations of current power machine poses by analyzing locational measurements over time, in combination with expected movement of a power machine (e.g., to correct predicted location from tractive control signals based on measured localization data from GPS devices). In some cases, including under approaches using extended Kalman filtering, uncertainty of localization data can also be tracked. Thus, in some embodiments, operations of a power machine can also sometimes be controlled based on certainty regarding the current pose of the power machine, including as further discussed below.

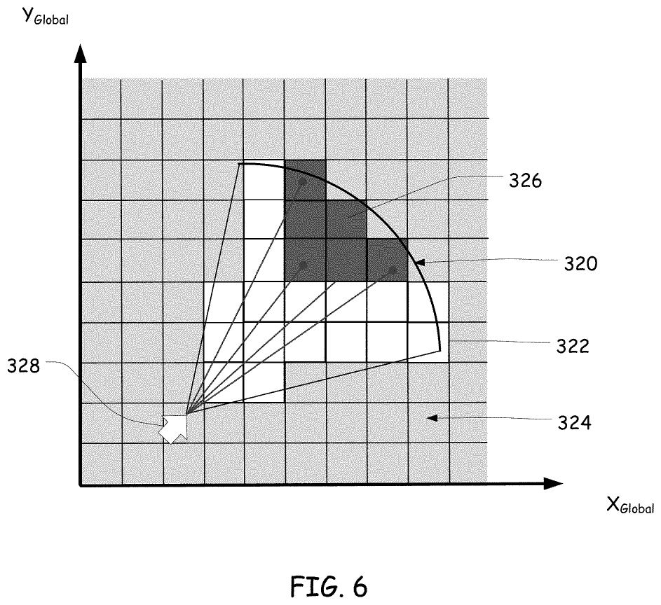

After or concurrent with localization of a power machine at block 302 to determine a current pose 316 of the power machine, the method 300 can include mapping operations at block 304 to provide a virtual map of relevant (e.g., adjacent and surrounding) terrain, including obstacles or objects also present in the terrain. Generally, mapping operations can account for known obstacles or other aspects of terrain and for unknown obstacles or other aspects of terrain, as determined based on external terrain data (e.g., from radar or other sensor input). Some known approaches can use probabilistic occupancy techniques, in which an occupancy grid of a virtual map is populated with a certainty (or likelihood) value relating to the calculated probability that an obstacle (or other notable geometrical aspect) is present in each grid cell (e.g., for each 0.25 m×0.25 m portion of a relevant area of terrain). As updated data regarding terrain is received, including via regular radar scans over a particular angular and distance range, certainty values of the occupancy grid can then be updated (e.g., increased based on radar hits on a previously unknown or uncertain obstacle for a particular grid cell). Thus, as shown in FIG. 6, for example, some portions 320 of an occupancy grid (shown on an XGlobal and YGlobal coordinate frame) can indicate probable obstacles (e.g., as corresponding to a similarly shaped real world obstacle 326), some portions 322 can indicate probable free space, and some portions 324 may be uncertain (e.g., because not recently scanned by radar or not otherwise stored in memory) relative to travel by a power machine 328.

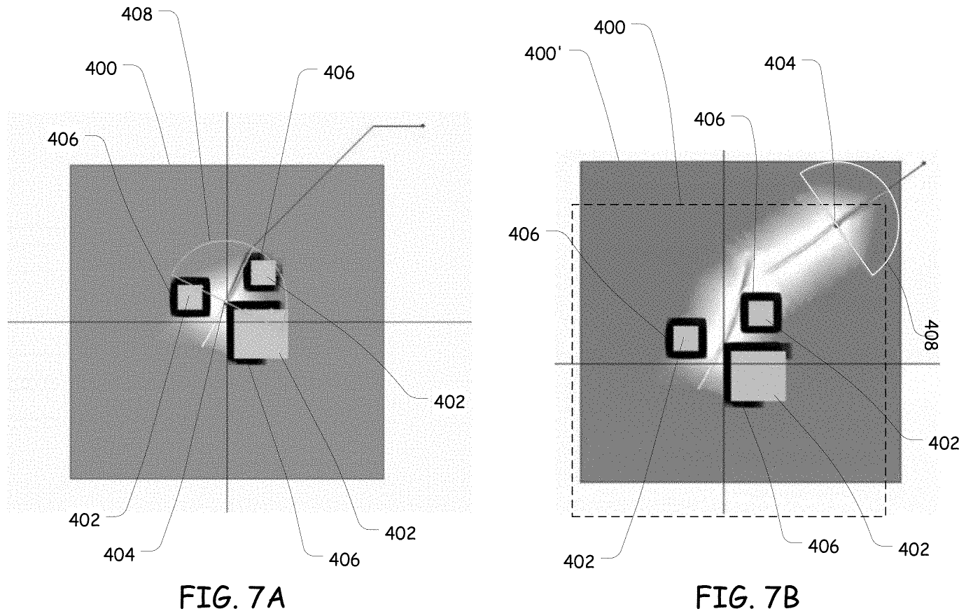

In some cases, a buffer zone can be provided around obstacles in a virtual map of terrain, including to provide appropriate safety factors for travel of a power machine around obstacles, in view of relevant uncertainties for a control system. For example, as shown in FIG. 7A, a virtual map 400 includes a plurality of obstacles 402 that have been identified with sufficient confidence (e.g., with certainty greater than 50%) to be represented as areas to avoid during travel of a power machine represented at 404 (i.e., as “obstacles” for path planning purposes). Further, buffer zones 406 have been identified around (e.g., fully or partly surrounding) each of the obstacles 402. In some cases, the buffer zones 406 can be treated effectively as obstacles to be avoided during path planning and automatic travel under the method 300 (see FIG. 5). Or the buffer zones 406 can be otherwise particularly treated. For example, travel may be permitted in some buffer zones, but at reduced speeds. In some cases, buffer zones can be scaled to correspond the size of a relevant power machine (e.g., can extend from a detected or pre-known obstacle by a distance that is substantially the same as an operational width or turning radius, etc. of a power machine).

As also shown in FIG. 7A, the range of a radar scan area 408 of the power machine 404 may be substantially smaller than a total area of terrain represented by a virtual map. Thus, for example, certainty values may more accurately represent actual characteristics of terrain (e.g., the presence of obstacles in particular grids) over a limited area of terrain, particularly focused on areas within and toward which a power machine is currently traveling.

As a related effect, as a power machine moves over terrain, the power machine may eventually approach one or more edges of a virtual map that is guiding the automatic travel. In some cases, a virtual map can thus be updated, as appropriate, to incorporate new regions of terrain. In some embodiments, the region of terrain covered by a virtual map can be updated based on a scanning area of a power machine reaching one or more boundary edges of a previously-constituted virtual map. For example, as shown in FIG. 7B, the power machine 404 has navigated sufficiently far beyond the obstacles 402, also avoiding the updated buffer regions 406, so that parts of the radar scan range 408 extend past the boundaries of the previously mapped area (indicated by the dashed representation of the map 400). Thus, although the total area represented by the updated virtual map 400′ remains the same as the total area represented by the initial virtual map 400, as can allow for operation with relatively small total memory, the coverage of the updated virtual map 400′ has also been updated to cover more a relevant area of terrain, based on radar scans by the power machine 400 as the power machine 400 travels.

In some embodiments, a control system for mapping terrain (e.g., as can implement parts of the method 300) can use a circular (or “ring”) buffer architecture to store map data. Under known principles, circular buffers can generally operate with a fixed amount of total storage and a sequential and repeating (i.e., circular) writing and over-writing progression for data blocks within the buffer, as can effectively result in a first-written—first-overwritten management of data for the fixed storage size. Some power machines may include a relatively small amount of available memory for mapping, so use of a circular buffer for mapping operations can sometimes be particularly useful for power machine operations.

Generally, as updated map information is received (e.g., based on radar scans by the power machine 404), confidence values or other parameters for grids of a virtual map can be updated as needed. Further, as movement of a power machine extends a scanned area to a different region of terrain, grid cells with older and more spatially distant confidence values (i.e., less relevant grid cells) can be effectively reallocated to represent new regions of terrain (e.g., new regions within the virtual map 400′ as compared to the map 400). In some cases, as a power machine moves relative to a virtual map stored in a circular buffer, an accurate allocation of grid cells of the map to particular real-world areas of terrain can be maintained, despite the moving reference frame of the power machine, simply by updating an offset value for the circular buffer (e.g., a location of the power machine 404 or other origin relative to grid cells of a current virtual map). As with other approaches noted above, use of such an adaptive offset value, particularly in combination with a circular buffer for mapping data, can generally improve power machine performance, including via reduction in required memory space and processor time.

Returning to FIG. 5, with mapping operations at block 304 having established a map with appropriate confidence and spatial range, the method 300 can further include path planning at block 306. In this regard, a variety of known approaches, including A*, D* Lite, breadth-first search, depth-first search, uniform cost search, or other algorithms, can be used to identify a planned path for a power machine between a starting location (e.g., an initial or current pose 316 of the power machine) and a destination 320 (e.g., a fixed location within an area of terrain as input by an operator). Also, as generally discussed above relative to FIGS. 7A and 7B, the sensing (e.g., radar) range of a power machine may not necessarily extend over an entire mapped area of terrain. Accordingly, like obstacle information, planned paths can sometimes be adaptively updated during travel across terrain, based on updated terrain information, including using A* algorithms or other various known approaches.

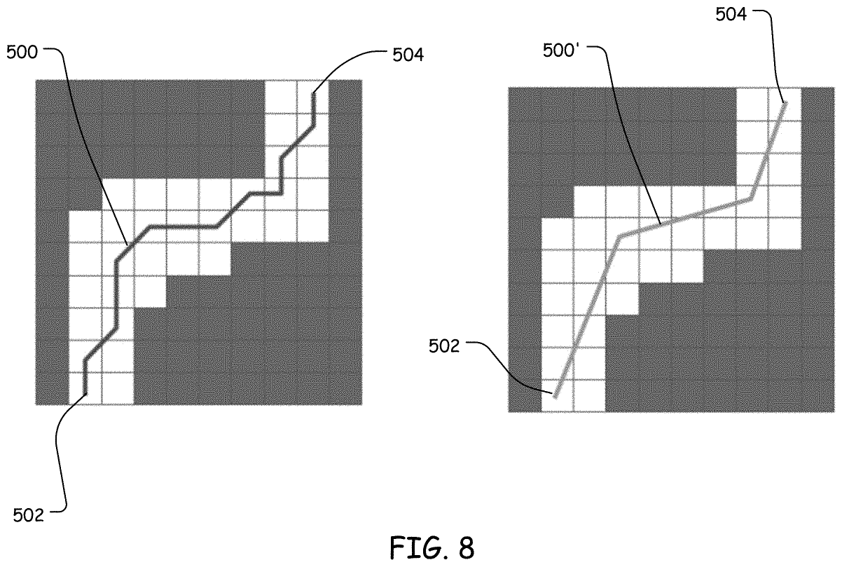

In some embodiments, once an initial path has been identified, additional path smoothing can be implemented, including to provide a shorter overall travel path or otherwise improve performance (e.g., reduce jerkiness during travel). A variety of path smoothing approaches are possible, including line-of-sight smoothing, an example of which as illustrated in FIG. 8. In the illustrated example, an initial shortest path 500 between a starting location 502 and a destination 504 has been determined using only straight-line segments between center points of adjacent grid cells. Using known algorithms, a smoothed shortest path 500′ can then be constructed, e.g., by maximizing the length of linear segments between distant centerpoints of grid cells. without the line segments intersecting an obstacle or associated buffer. Although line-of-sight smoothing can be useful in some cases, other known approaches to path smoothing can also be employed.

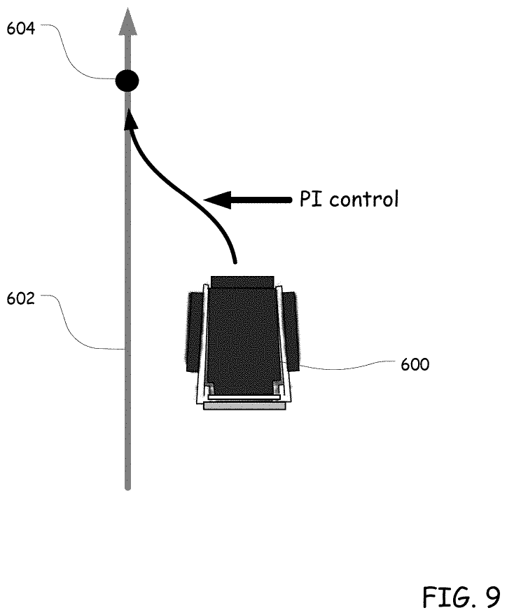

Referring again to FIG. 5 and also to FIG. 9, once a planned path has been appropriately determined, the method 300 can include tracking operations at block 308 to determine travel parameters (e.g., target velocities) for a power machine, based on the planned path. As shown in FIG. 9 in particular, a current pose of a power machine 600 may not necessarily overlay a planned path 602 at all times (e.g., as assessed relative to a geometric centerline or other fixed reference point of the power machine 600). However, tracking operations can proceed at block 308 similarly in either case. In this regard, for example, rather than determine that the power machine 600 should proceed to the planned path 602 as quickly as possible (e.g., along a shortest return line), a control system can identify (e.g., in operations at block 308) a target point 604 along the path 602 that is spaced apart from the power machine relative to an intended direction of travel along the path 602 (e.g., in the upward direction on the page in the example of FIG. 9). Travel parameters 310 can then be determined for the power machine 600 to travel toward the target point 604 (e.g., rather merely than to the travel path 602 in general), and corresponding commands 324 for work elements of the power machine 600 can then be also determined and relayed, as needed (e.g., as implemented via block 322). Generally, to control tracking of a known target point along a path (e.g., the target point 604, determined as explained above), a variety of approaches are possible, including known pure pursuit algorithms with PI control (as shown), for correction of power machine heading via adjustments to angular velocity.

In some embodiments, a target point may be located along a path at a particular set distance from a power machine. For example, a target point can be located at a particular distance from the power machine, as measured directly between a reference point on the power machine and the target point or as measured along a planned path between the target point and a location on the panned path that is closest to the power machine. Correspondingly, a target point may tend to move along a planned path as a power machine travels along (e.g., tracks) the path. As generally discussed above, it may be useful in some cases to locate a tracking point as far distant from a power machine as is practically possible, as this can result in a smoother and more natural trajectory for some operations, particularly when the robot approaches sharp corners.

In some cases, an optimal distance between a power machine and a target point may vary depending on operating conditions for the power machine, aspects of a planned path (or corresponding terrain), or other factors. For example, although a larger distance for a target point can result in smoother travel overall, the larger distance can also result in a power machine cutting off substantial portions of a path along sharper turns (e.g., square or sharper corners) or at higher speeds. Further, although a smaller distance for a target point can result in less substantial cutting of corners, the smaller distance can also result in substantial overshooting of a path at sharper path turns or at higher speeds.

Thus, in some embodiments, as part of tracking of a planned path (e.g., at block 308), a control system can automatically update a distance of the target point from a power machine (i.e., from an arbitrary reference point on the power machine) based on a local curvature of the planned path, a travel speed of the power machine, or other factors. For example, along straighter (i.e., lower curvature) portions of a path or during travel at higher speeds, a control system can automatically provide a target point at larger distances from a power machine. Likewise, a target point can be automatically provided at smaller distances near or along higher curvature portions of a path or during travel at lower speeds. Thus, for example, some embodiments can allow power machines to automatically navigate a planned path with relatively high fidelity during turns or other low-speed maneuvers, while also maintaining relatively smooth movement during straighter travel or other high-speed maneuvers.

In some embodiments, locating a target point relative to a power machine can be based on speed (e.g., can vary proportionally with speed) or can be based on path curvature (e.g., can vary inversely with curvature). For example, some control systems can operate to automatically decrease a commanded travel speed of a power machine based on current or anticipated increases in the local curvature of a planned path (e.g., for upcoming turns) and can automatically increase a commanded travel speed of the power machine based on current or anticipated decreases in the local curvature of the planned path (e.g., for upcoming straight-aways). Further, and similarly, a distance of a target point from a power machine can be automatically reduced at lower speeds and can automatically be increased at higher speeds (e.g., according to the assumption that lower speeds correspond to higher curvature areas of the path). Thus, in short, in some embodiments, power machine speed can be reduced or increased based on geometric aspects of a planned path, and a target point can be moved closer to or farther from a power machine based on power machine speed.

In some cases, combined control of speed based on curvature and control of target point location based on speed may provide for particularly efficient computation and control, including because velocity control can be fundamentally separated from calculations to determine a tracking point location, as may allow for more flexible control device architectures and data flows. Further, operator tuning may be more intuitive under this approach than under others. However, in some embodiments, similar control can be implemented in other ways, including by determining target-point distance or travel speed in different orders or based on different parameters.

In different embodiments, different correspondence between path curvature, travel speed, and target-point location can be used. In some cases, path curvature can be mapped to travel speed based on a lookup table that can be initially populated or calibrated (and later tuned) based on the operational characteristics of a particular power machine, the preferences of a particular operator, characteristics of the relevant terrain, etc. Likewise, in some cases, travel speed can be linearly mapped to distance of a target point for pursuit tracking based on a predetermined minimum and maximum possible distance of a target and a minimum and maximum travel speed. This noted approach may prove particularly effective in systems with limited available processing power. However, particular target-point distances can also be associated with particular speeds, curvatures, or other factors in a variety of other ways.

In some embodiments, a reduced distance for a target point may be implemented only until a power machine has substantially (or fully) completed a particular operation. For example, as a power machine travels at lower speeds through an initial portion of a turn on a path, a target point for pursuit tracking by the power machine may be at a minimum distance from the power machine. Once the power machine completes some portion of the turn, however, the distance of target point may be automatically increased to a particular value or range. For example, once a power machine substantially (or fully) completes a turn, a target point for pursuit tracking may be automatically moved to a maximum distance from the power machine. In some cases, a target-point distance may be increased to a maximum distance as a step (or stepped) change. In some cases, the distance can be increased gradually to a maximum (e.g., linearly with travel distance).

In some embodiments, the correspondence among path curvature, travel speed, and target-point distance may be tunable, to provide customizable operating characteristics for particular terrain, operators, tasks, etc. For example, different operating modes can include a variety of different preset correspondences between travel speed (or curvature) and target-point distance, to provide for maximum-speed operation, open-space operation (e.g., with minimal expected obstacles), close-constraint operation (e.g., to maximize avoidance of numerous, sensitive, or otherwise notable obstacles), etc. As desired, an operator can then select a particular operating mode for execution of particular power machine operations.

In some embodiments, particular mappings among path curvature, travel speed, and target-point distance can be determined based on uncertainty values associated with mapping or localization operations (see, e.g., FIG. 5). For example, travel speed or target-point distance may sometimes be reduced based on elevated uncertainty measurements from extended Kalman filtering (or other analysis) to determine a current power machine pose or based on elevated uncertainty regarding obstacle locations within a virtual map.

In some embodiments, a distance of a target point from a power machine can be determined based partly on operational characteristics of the power machine. As noted above, for example, target-point distance can be based on vehicle speed. In some cases, target-point distance can additionally (or alternatively) be based on turning radius, maximum speed, minimum speed, or other characteristics of a particular power machine. For example, a minimum or maximum target-point distance can be set based on a turning radius of a power machine or a minimum or maximum expected travel speed of the power machine.

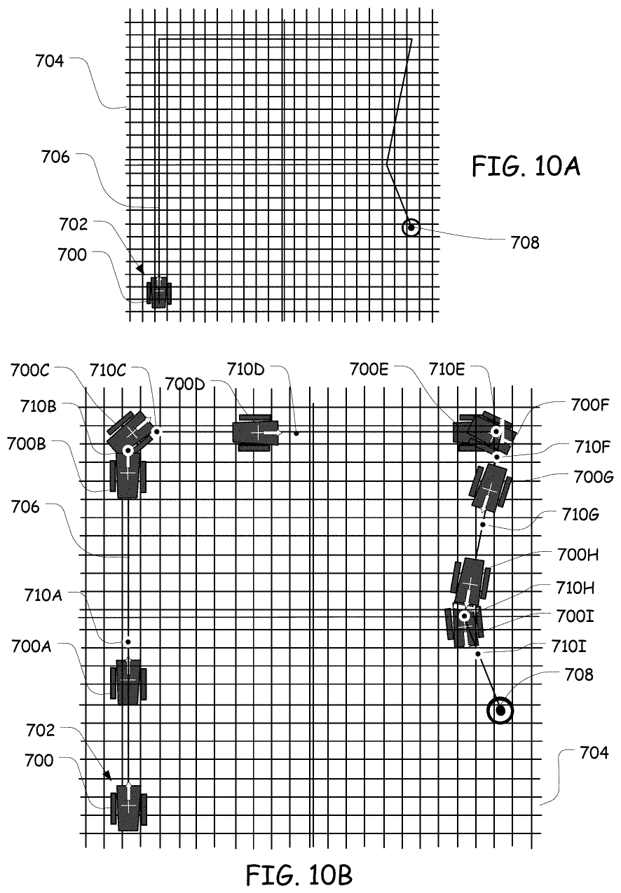

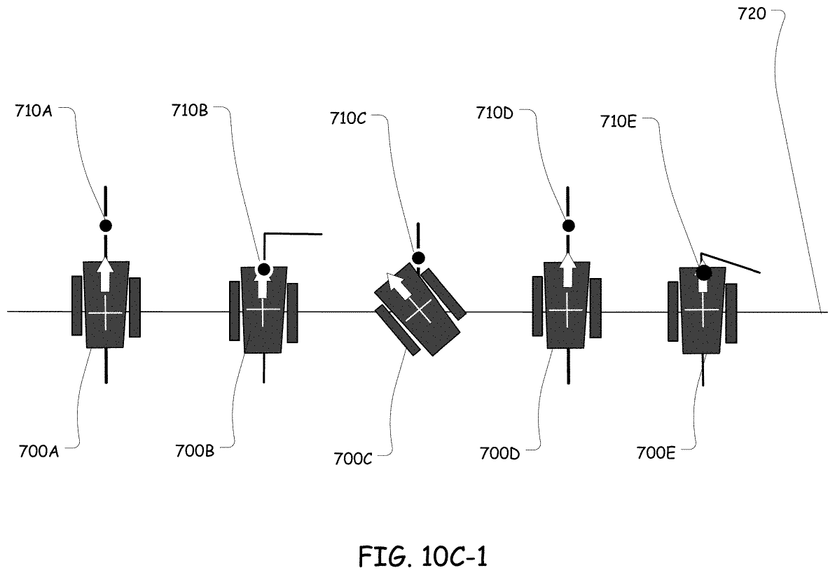

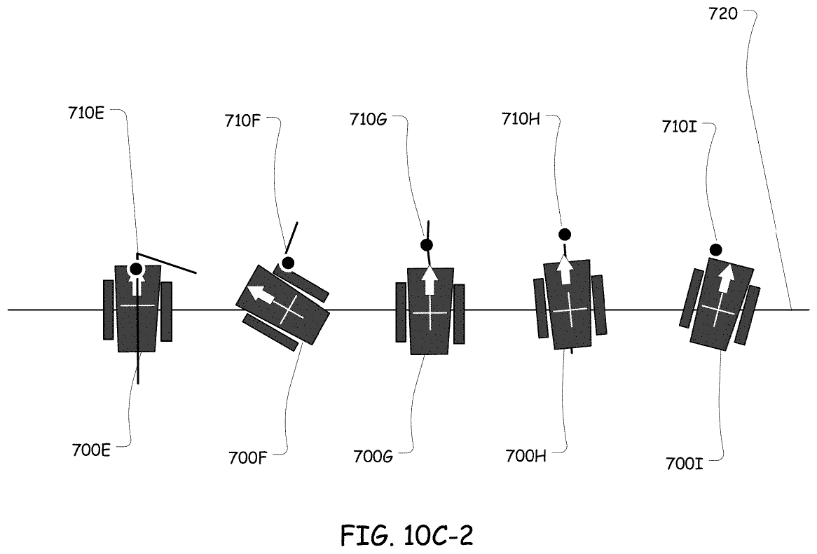

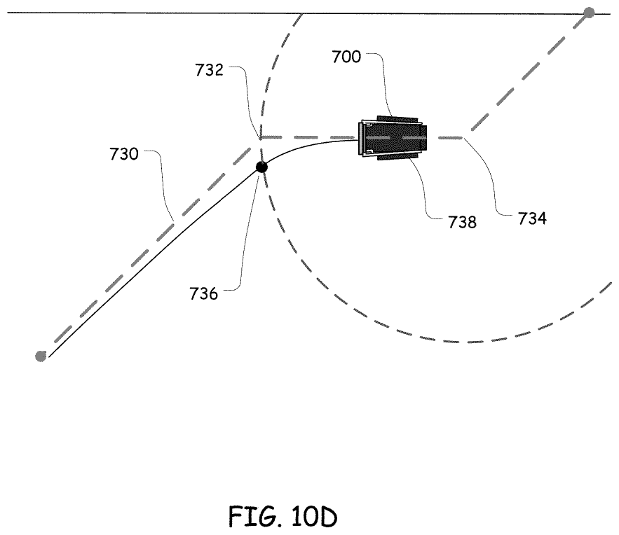

An example implementation of the method 300 and various specific operations discussed above is illustrated in FIGS. 10A through 10C. (FIG. 10C is divided into sub-figures 10C-1 and 10C-2 with commonly included power machine localization 700E and reference line 720 and common vertical scaling.) In particular, FIG. 10A shows a power machine 700 that has been localized at a starting location 702 on a virtual map 704. A planned path 706 between the starting location 702 and a destination 708. FIGS. 10B and 10C show the power machine 700 during subsequent tracking of the path 706 by the power machine 700, with select successive localizations of the power machine 700 indicated as 700A, 700B, etc., and corresponding target points indicated as 710A, 710B, etc., respectively. In particular, FIG. 10B shows the power machine 700 in the context of the entire path 706, whereas FIG. 10C shows the power machine 700 as isolated during select localizations, with a normalized orientation so that the distance of the various target points 710A, etc. from a reference point (e.g., center of gravity, or center of rotation) of the power machine 700 is illustrated as a vertical distance above a reference line 720.

Referring to FIGS. 10B and 10C in particular, as the power machine 700 travels along straight portions of the path 706 (see localizations 700A, 700D, 700G), distances of the associated target points (see points 710A, 710D, 710G) are at a maximum value (e.g., a common maximum value, as shown). As the power machine 700 approaches and navigates turns along the path 706, however, distances of the associated target points (see points 710B, 710C, 710E, 710F, 710H, 710I) are reduced.

Further, with reference to FIG. 10C in particular, the scale of reduction of the distances of the target points from a maximum distance is proportional to the local curvature of the path 706 (see FIG. 10B) and also correlated with a distance of the power machine 700 from a relevant turn or a degree of progress of the power machine 700 through the turn. For example, the distances for the target points 710B and 7101E have been reduced to a minimum before the power machine 700 enters the associated turn, due to the relatively high curvature of the turns (e.g., each having an angle of 90-degrees or more). In contrast, the distance for the target point 710H is reduced from maximum, but still substantially above minimum, due to the relatively small curvature of the associated turn. Similarly, a reduction in the distance for target points near the target point 710H may start somewhat closer to the associated turn, due to the lower local curvature, than for the turns associated with the target points 710B, 710E.

Continuing, in the illustrated example, the distances for the target points 710C, 710F also remain relatively small, albeit above a minimum setting, at least until the power machine 700 substantially completes the associated turn. However, the distance for the target point 710H has been returned toward a maximum value substantially sooner, relative to progress through the associated turn, due to the lower curvature of the turn. Correspondingly, in some embodiments, a target-point distance (e.g., near the target points 710C, 710F, 710H) can sometimes be increased beyond a predetermined threshold (e.g., to a maximum value) only after a power machine has substantially completed a turn or other relevant operation.

By way of example in this regard, FIG. 10D illustrates the power machine 700 during travel along a path 730 that includes a first turn 732 and a second turn 734. In the illustrated example, a target-point distance was automatically increased once the power machine 700 reached a point 736 that corresponds to substantial completion of the turn 732 by the power machine 700, relative to the center of gravity 738 of the power machine 700. In the illustrated example, substantial completion of the turn 732 coincides with the power machine 700 being closer to the waypoint of the second turn 734 than to the waypoint of the first turn 732 (as shown by the dashed circle centered at the turn 734). In a turn between straight-line paths, substantial completion of the turn can coincide with the center of gravity of the power machine being past a mid-point of the turn.

The behavior of target-point distance relative to path curvature and substantial completion of turns, as illustrated in FIGS. 10B through 10D, can be particularly beneficial in some cases, including relative to the differences between different types of turns along the path 706. However, as generally discussed above, a variety of other particular relationships between target-point distance, travel speed, and path curvature can be implemented, as needed.

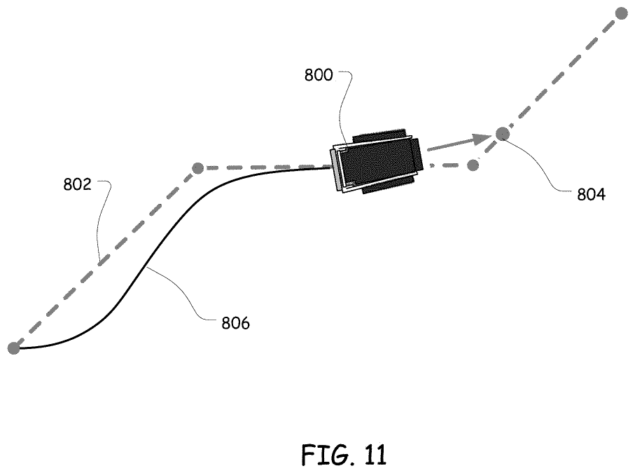

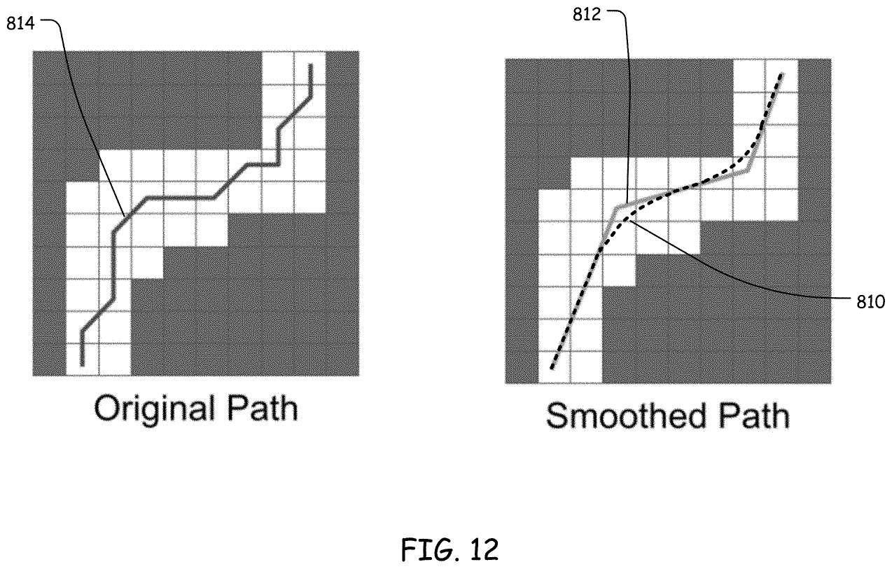

As generally noted above, pursuit tracking operations to follow a planned path can sometimes effectively result in supplemental smoothing of a travel path of a power machine. For example, as shown in FIG. 11, as a power machine 800 tracks a planned path 802 based on adaptive positioning of a target point 804 (e.g., as discussed generally above), the power machine 800 can follow an actual path 806 that is smoother and, in some cases, locally or globally shorter than the planned path 802. In some cases, this type of pursuit-based smoothing can thus layer additional path smoothing over the results of previous smoothing operations (e.g., as applied during path planning operations (see FIG. 5)). Referring also to FIG. 12, for example, based on pursuit tracking with adaptive positioning of a target point, a power machine can follow a smoothed actual path 810 that suitably avoids obstacles, while also being both locally and globally shorter than even a line-of-sight smoothed path 812 (e.g., as based on an original path 814).

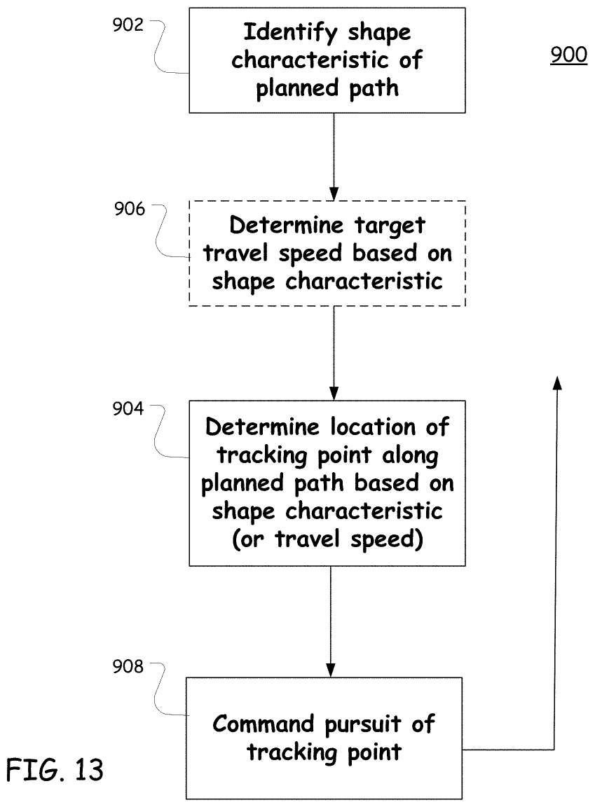

Consistent with the discussion above, some embodiments can include a control method 900, as shown in FIG. 13, which can be implemented, alone, as an included or substitute module relative to the method 300 (see FIG. 5), or as part of other control methods. In particular, in the illustrated example, the method 900 includes identifying at block 902 a shape characteristic of a planned path for the power machine. For example, an initial or updated planned path can be determined according to the method 300 and then a control device can identify local curvature or other characteristics of the shape of the planned path, including so as to identify turns or other regions where more closely located target points may be useful.

Continuing, the method 900 can further include determining at block 904 a location of a target point along the planned path for pursuit tracking by the power machine. For example, as similarly discussed above, a location of a tracking point can be determined at block 904 based on setting a larger distance from a power machine for certain portions of a path (e.g., less curved portions) and a smaller distance from the power machine for other portions of the path (e.g., more curved portions).

In some cases, also as noted above, determining (at block 904) a location of at target point based on path characteristics can sometimes be further (or alternatively) based on travel speed (e.g., on an intervening control of travel speed). For example, in some implementations, the method 900 can further include determining at block 906 a target travel speed for a power machine based on the identified (at block 902) shape characteristics (e.g., local curvature) of a planned path. Correspondingly, for example, determining at block 904 the location of a target point can sometimes be based directly on a determined (at block 906) travel speed for a power machine, and can thus be only indirectly based on the identified (at block 902) shape characteristic.

As generally noted above, once a location of a tracking point has been determined at block 904, pursuit of the tracking point by a power machine can then be commanded at block 908, including based on a variety of known control architectures for automatic activation of work elements of a power machine. Further, as path-tracking travel of a power machine continues, the method 900 can repeat as needed, in whole or in part. For example, an additional (e.g., spatially approaching) characteristic of the planned path can be identified (at block 902), an updated location of a tracking point can be determined accordingly (at block 904), and then updated pursuit of the tracking point can be commanded (at 908).

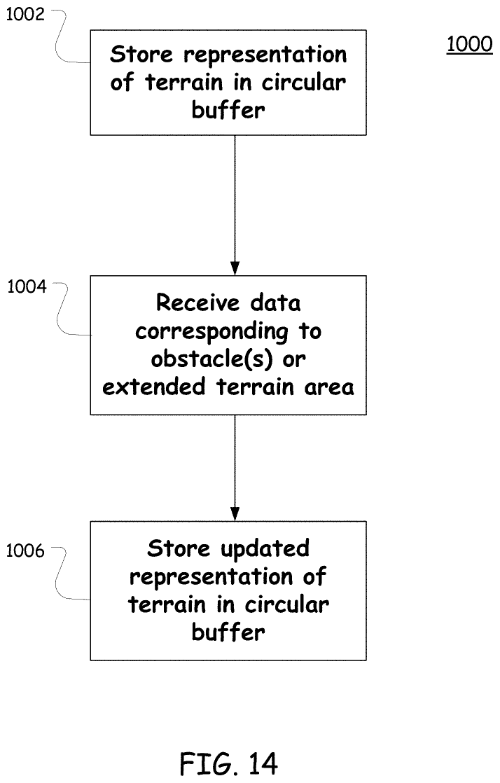

Also consistent with the discussion above, some embodiments can include a control method 1000, as shown in FIG. 14, which can be implemented, alone, as an included or substitute module relative to the method 300 (see FIG. 5) or the method 900 (see FIG. 13), or as part of other control methods. In particular, in the illustrated example, the method 1000 includes storing at block 1002, in a circular buffer module, an initial representation of a first area of terrain. For example, grid data for a virtual map corresponding to a first area (e.g., as shown by the map 400 in FIG. 7A) can be stored in a circular buffer memory architecture to characterize the likelihood that an obstacle is present in any particular grid cell.

As the method 1000 continues, data can be received at block 1004 from one or more sensors, as may correspond to one or more potential obstacles within the terrain, or to a second area of the terrain that extends beyond an edge of the first area of the terrain. For example, updated data from radar scans may correspond to changes in certainty values for particular grid cells based on occurrence or non-occurrence of radar pings, or may correspond to an extension of map data to a second area that is different from the first area (e.g., as shown by the map 400′ in FIG. 7B). As used herein, potential obstacles indicates an object or other phenomenon that can result in sensor data corresponding to an actual object in an area of terrain. In some cases, potential obstacles can be actual obstacles (e.g., actual objects or terrain features), including previously unknown obstacles (i.e., obstacles not included in a current representation of the relevant area of terrain). In some cases, potential obstacles can be false obstacles (i.e., artifacts of sensor data that have characteristics of sensor data for actual obstacles but do not correspond to actual obstacles in the actual terrain).

As generally noted above, an updated representation of terrain can then be stored at block 1006 in the circular buffer, with data being written and over-written according to known general principles of data management for circular buffers. For example, a stored updated representation of terrain can include an updated (or new) representation of one or more detected potential obstacles within the terrain, or a representation of the second area of the terrain that extends beyond an edge of the first area of the terrain, which may result in the overwriting of older data within the buffer.

In some implementations, other operations may also be included, including operations that are also discussed generally above. For example, some implementations can include storing an offset for the circular buffer that locates (i.e., localizes) the power machine relative a first area of terrain, as represented by map data in the circular buffer. As appropriate, the offset can then be updated based on received data (at block 1004) that relates to a second, different area of terrain or that otherwise indicates a movement of the power machine relative to the first area of terrain. In some embodiments, a spatial area of terrain that is represented by a stored (at block 1006) updated representation may be of substantially the same total size as a spatial area of terrain within the initial representation (e.g., as shown for the maps 400, 400′ in FIGS. 7A and 7B), such that both spatial areas can be represented by a constant-size circular buffer with the same resolution.

In some embodiments, aspects of the invention, including computerized implementations of methods according to the invention, can be implemented as a system, method, apparatus, or article of manufacture using standard programming or engineering techniques to produce software, firmware, hardware, or any combination thereof to control a processor device (e.g., a serial or parallel general purpose or specialized processor chip, a single- or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, embodiments of the invention can be implemented as a set of instructions, tangibly embodied on a non-transitory computer-readable media, such that a processor device can implement the instructions based upon reading the instructions from the computer-readable media. Some embodiments of the invention can include (or utilize) a control device such as an automation device, a special purpose or general purpose computer including various computer hardware, software, firmware, and so on, consistent with the discussion below. As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.).

The term “article of manufacture” as used herein is intended to encompass a computer program accessible from any computer-readable device, carrier (e.g., non-transitory signals), or media (e.g., non-transitory media). For example, computer-readable media can include but are not limited to magnetic storage devices (e.g., hard disk, floppy disk, magnetic strips, and so on), optical disks (e.g., compact disk (CD), digital versatile disk (DVD), and so on), smart cards, and flash memory devices (e.g., card, stick, and so on). Additionally, it should be appreciated that a carrier wave can be employed to carry computer-readable electronic data such as those used in transmitting and receiving electronic mail or in accessing a network such as the Internet or a local area network (LAN). Those skilled in the art will recognize that many modifications may be made to these configurations without departing from the scope or spirit of the claimed subject matter.

Certain operations of methods according to the invention, or of systems executing those methods, may be represented schematically in the FIGS. or otherwise discussed herein. Unless otherwise specified or limited, representation in the FIGS. of particular operations in particular spatial order may not necessarily require those operations to be executed in a particular sequence corresponding to the particular spatial order. Correspondingly, certain operations represented in the FIGS., or otherwise disclosed herein, can be executed in different orders than are expressly illustrated or described, as appropriate for particular embodiments of the invention. Further, in some embodiments, certain operations can be executed in parallel, including by dedicated parallel processing devices, or separate computing devices configured to interoperate as part of a large system.

As used herein in the context of computer implementation, unless otherwise specified or limited, the terms “component,” “system,” “module,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) may reside within a process or thread of execution, may be localized on one computer, may be distributed between two or more computers or other processor devices, or may be included within another component (or system, module, and so on).

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “only one of” or “exactly one of” For example, a list of “one of A, B, or C” indicates options of: A, but not B and C; B, but not A and C; and C, but not A and B. A list preceded by “one or more” (and variations thereon, e.g., “at least one of”) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

Also as used herein, unless otherwise expressly limited or defined, the term “automatic operations” (and the like) refers to operations that are at least partly dependent on electronic application of computer algorithms for decision-making without human intervention. In this regard, unless otherwise expressly limited or defined, “automatic travel” refers to travel of a power machine or other vehicle in which at least some decisions regarding steering, speed, distance, or other travel parameters are made without direct intervention by a human operator. Relatedly, the term “automated operations” (and the like), unless otherwise expressly limited or defined, refers to a subset of automatic operations for which no intervention by a human operator is required. For example, automated travel can refer to automatic travel of a power machine or other vehicle during which steering, speed, distance, or other travel parameters are determined in real time without operator input. In this regard, however, operator input may sometimes be received to start, stop, interrupt, or define parameters (e.g., top speed) for automated travel or other automated operations.

Although the present invention has been described with reference to preferred embodiments, workers skilled in the art will recognize that changes may be made in form and detail to the disclosed embodiments without departing from the spirit and scope of the concepts discussed herein.

What is claimed is:

1. A method for controlling travel of a power machine, the method comprising:
identifying, using one or more processor devices, a planned path for travel of the power machine between a starting location and a destination;
determining a target point along the planned path, using one or more processor devices, based on a set distance of the target point from the power machine, and commanding travel of the power machine toward the target point;
controlling one or more tractive elements of the power machine, using one or more processor devices, to cause the power machine to automatically travel toward the target point;
as the power machine automatically travels toward the target point, updating the set distance, using one or more processor devices, based on one or more of a local curvature of the planned path or a travel speed of the power machine; and
as the power machine automatically travels toward the target point, updating, using one or more processor devices, a location of the target point along the planned path based on the updated set distance.

2. The method of claim 1, wherein updating the set distance of the target point from the power machine includes increasing the set distance based on an increase in the travel speed of the power machine and decreasing the set distance based on a decrease in the travel speed of the power machine.

3. The method of claim 2, further comprising: automatically decreasing a commanded travel speed of the power machine based on increases in the local curvature of the planned path and automatically increasing the commanded travel speed of the power machine based on decreases in the local curvature of the planned path.

4. The method of claim 1, wherein controlling the one or more tractive elements to cause the power machine to automatically travel toward the target point causes the power machine to deviate from the planned path.

5. The method of claim 4, wherein the deviation from the planned path results in an actual travel path of the power machine that is locally shorter than the planned path, between common endpoints along the planned path.

6. The method of claim 5, wherein the deviation from the planned path results in a total actual travel path of the power machine from the starting location to the destination that is shorter than the planned path as measured from the starting location to the destination.

7. The method of claim 1, wherein updating the set distance of the target point from the power machine is further based on a selection of at least one operating mode of a plurality of predetermined operating modes for path tracking by the power machine.

8. The method of claim 1, wherein updating the set distance of the target point from the power machine is further based on a turning radius of the power machine.

9. The method of claim 1, wherein updating the set distance of the target point from the power machine includes increasing the set distance to a maximum value upon substantial completion of a turn along the planned path.

10. A power machine configured for automatic operations, the power machine comprising:
a main frame;
one or more tractive elements configured to move the main frame over terrain;
one or more work elements supported by the main frame;
a power source supported by the main frame and configured to provide tractive power to the one or more tractive elements and to provide working power to the one or more work elements; and
a control system that includes one or more processor devices configured to:
identify a first local curvature of a planned path for automatic travel of the power machine;
set a first target travel speed for the power machine based on the first local curvature;
determine a current location for the power machine;
identify a first location of a target point along the planned path, based on the current location of the power machine and one or more of the first local curvature or the first target travel speed; and
control automatic travel of the power machine, including commanding a first heading for the power machine based on the identified first location of the target point to automatically control travel of the power machine.

11. The power machine of claim 10, wherein identifying the first location of the target point along the planned path, based on the one or more of the first local curvature or the first target travel speed, includes determining the first target travel speed based on the first local curvature and identifying the location of the target point based on the first target travel speed.

12. The power machine of claim 11, wherein the one or more processor devices are configured to:
as the power machine travels toward the target point along the first heading, identify an updated location of the target point along the planned path, based on one or more of a second local curvature of the planned path or a second travel speed of the power machine; and
further control automatic travel of the power machine, including commanding an updated heading for the power machine based on the identified updated location of the target point.

13. The power machine of claim 12, wherein identifying the updated location of the target point includes, as the power machine travels toward the target point, updating a distance between the power machine and the target point based on one or more of the second local curvature of the planned path or the second travel speed of the power machine.

14. The power machine of claim 12, wherein automatically controlling the travel of the power machine includes:
automatically increasing a distance between the target point and a reference location on the power machine based on an increase in the travel speed of the power machine;
automatically decreasing the distance between the target point and the reference location based on a decrease in the travel speed of the power machine;
automatically decreasing a commanded travel speed of the power machine based on increases in local curvature of the planned path; and
automatically increasing the commanded travel speed of the power machine based on decreases in local curvature of the planned path.

15. The power machine of claim 10, wherein the one or more processor devices are configured to:
receive user input indicating a selection of an operating mode from a plurality of operating modes; and
in response to receiving the user input, operating the power machine for automatic travel in the selected operating mode, wherein each of the plurality of operating modes specifies a respective correspondence between (a) a distance between the power machine and the target point and (b) one or more of: travel speed of the power machine or local curvature of the planned path.

16. The power machine of claim 10, further comprising:
one or more sensors arranged to detect data representing aspects of the terrain;
wherein the control system further includes a circular buffer memory structure; and
wherein the control system is configured to:
store in the circular buffer memory structure an initial map of a first area of the terrain;
receive data from the one or more sensors representing one or more of: one or more potential obstacles within the terrain, or a second area of the terrain that extends beyond an edge of the first area of the terrain; and
store an updated map of the terrain in the circular buffer memory structure, including a representation of the one or more of: the one or more potential obstacles within the terrain, or the second area of the terrain that extends beyond an edge of the first area of the terrain.

17. The power machine of claim 16, wherein storing the updated map overwrites at least part of the initial map within the circular buffer memory structure.

18. A power machine configured for automatic operations, the power machine comprising:
a main frame;
one or more tractive elements configured to move the main frame over terrain;
a power source supported by the main frame and configured to provide tractive power to the one or more tractive elements; and
a control system that includes a circular buffer module and one or more processor devices configured to:
store in the circular buffer module an initial representation of a first area of the terrain;
control automatic travel of the power machine, including commanding first tractive operations by the one or more tractive elements based on the initial representation of the terrain;
receive data from one or more sensors corresponding to one or more of: one or more potential obstacles within the terrain, or a second area of the terrain that extends beyond an edge of the first area of the terrain;
store an updated representation of the terrain in the circular buffer, including a representation of the one or more of: the one or more potential obstacles within the terrain, or the second area of the terrain that extends beyond an edge of the first area of the terrain; and
further control automatic travel of the power machine, including commanding second tractive operations by the one or more tractive elements based on the updated representation of the terrain.

19. The power machine of claim 18, wherein the control system is further configured to:
store an offset for the circular buffer that locates the power machine within the first area of the terrain; and
update the offset based upon receiving the data corresponding to the second area of the terrain.

20. The power machine of claim 19, wherein the second area of the terrain represented by the updated representation is of substantially the same areal size as the first area of the terrain represented by the initial representation.
